(19) United States
(12) Patent Application Publication
(10) Pub. No.: US 2022/0019091 A1
(43) Pub. Date: Jan. 20, 2022

(54) APPARATUS FOR SUPPLYING ENERGY TO AND/OR COMMUNICATING WITH AN EYE IMPLANT BY MEANS OF ILLUMINATION RADIATION

(71) Applicant: Carl Zeiss AG, Oberkochen (DE)

(72) Inventors: Thomas NOBIS, Jena (DE); Tobias SCHMITT-MANDERBACH, Jena (DE); Daniel BUBLITZ, Rausdorf (DE)

(21) Appl. No.: 16/500,808

(22) PCT Filed: Mar. 21, 2018
(86) PCT No.: PCT/EP2018/057107

§ 371 Date: Oct. 3, 2019

(30) Foreign Application Priority Data
Apr. 5, 2017 (DE) 102017107346.9

(51) Int. Cl. G02C 11/04; G02C 11/00; H02J 50/30

(52) U.S. Cl. CPC G02C 11/04; H02J 50/30; G02C 11/10

(57) ABSTRACT

An apparatus for supplying energy to and/or communicating with an eye implant by means of illumination radiation is provided, wherein the apparatus comprises a positioning unit, which sets an illumination position of the eye of a user, an optical input interface, by means of which the illumination radiation is suppliable to the apparatus, and an illumination optical unit, wherein the illumination optical unit focuses the supplied illumination radiation in such a way that a focus with a lateral extent of at least 0.1 mm in air is present and such that, when the eye of the user is in the set illumination position, the illumination radiation enters into the eye as a convergent beam such that the focus lies within the eye.

### PRIORITY

This application claims the benefit of German Patent Application No. 102017107346.9 filed on Apr. 5, 2017, which is hereby incorporated herein by reference in its entirety.

### FIELD

The present invention relates to an apparatus for supplying energy to and/or communicating with an ocular implant by means of illumination radiation.

### BACKGROUND

The development of biocompatible electronics or electronics encapsulated in biocompatible fashion and general advances in bionics have led to numerous novel sensors and actuators that are implanted in the body, as a rule for medical reasons. On account of continual miniaturization of the electronic components, even surgical implants into the human eye have now been rendered possible.

Depending on the field of application, such implants can be introduced in the region of the cornea (e.g., electronic contact lens), in the anterior chamber or in the vicinity of the lens or iris (e.g., intraocular lens, mechanical iris, anterior chamber sensors), in the vitreous humor and on the retina (e.g., a retinal implant for restoring sight).

As a rule, a stable supply of energy is required for the operation of such electronic components. As a result of the complicated surgical intervention, the use of a battery, or the regular interchange thereof, is out of the question. Instead, the energy is usually supplied by way of inductive methods. To this end, additional conductor loops are introduced into the body in the vicinity of the actual implant. However, this requires much surgical outlay, particularly for electronic components close to the eye, and increases the risk of medical complications.

An alternative option consists in illuminating the implant with light. Light outside of the visible spectral range, e.g., infrared or ultraviolet light, is preferably used to this end. As a rule, this provided light is not bothersome to the human eye and/or the normal function of the implant. Consequently, the power transferred with the illumination light can be used as an energy source if the implant has corresponding sensitive receivers (solar cells) available.

A further application consists of employing this method of transfer for the purposes of communicating with the implant. In this case, the implant likewise requires receivers (photodiodes) and, optionally, transmitters (light sources). In this case, the transferring energy is of secondary importance. The goal lies in the transfer of information. By way of example, this is implemented by modulating the intensity or frequency of the transferred radiation.

In the case of retinal implants, there is the additional difficulty of the imaging properties of the constituent parts of the eye having an effect.

U.S. Pat. No. 9,474,902 B2 describes an illumination system for the case of a retinal implant for the partial restoration of sight. There, a coherent point light source is imaged and focused into the interior of a spectacle lens via a collimator and light guide. The radiation, divergent in that case, emerging from the spectacle lens illuminates the pupil of the eye and produces an illuminated circular spot on the retina that is sufficiently large for the application.

However, in the case of a small rotation of the eye through a few degrees, the provided light is vignetted on the pupil of the eye and no longer reaches as far as the retina. Even in the case of a slight lateral displacement of the eye, for example by 1 mm, the illuminated region is displaced on the retina, and so parts of the implant are no longer illuminated.

### SUMMARY

Provided is an improved apparatus for supplying energy to and/or communicating with an ocular implant by means of an illumination radiation.

Advantageously, robustness in relation to the lateral offset of the eye of the user with respect to the illumination optical unit and in relation to an axial offset of the eye with respect to the illumination optical unit is obtained using the apparatus according to the invention. By way of example, such an offset may occur if the apparatus has slightly slipped relative to the user or if the apparatus is designed for various users.

Robustness in relation to variations in the size of the pupil of the eye and in relation to variations in the angle of rotation of the eye in the eye socket can also be obtained.

Moreover, a high efficiency of the illumination radiation, which was made available, is present. Advantageously, exclusively illuminating the implant or the region of the implant requiring illumination is achieved to the best possible extent, with only little swamping. Further, it is possible to provide a homogeneous illumination pattern or a pattern that is matched to the receiver geometry. Additionally, remaining below safety-relevant limits of the radiant intensity for the individual parts of the human eye is ensured.

Here, the lateral extent of the focus of at least 0.1 mm in air is understood to mean, in particular, the extent present without the imaging property of the eye. Naturally, the extent of the focus in the eye may be modified by the imaging properties of the eye.

The lateral extent can be 0.2 mm, 0.3 mm, 0.4 mm, 0.5 mm, 0.6 mm, 0.7 mm, 0.8 mm, 0.9 mm, 1.0 mm and up to 3 mm (e.g., in 0.1 mm steps). Further, the lateral extent can be 6 mm to 0.5 mm (e.g., in 0.1 mm steps).

Additionally, the specified focal positions should preferably be understood to be focal positions present when the imaging properties of the eye are not taken into account. Consequently, an imagined position of the focus is preferably described, said position emerging from the points of intersection of imagined continuations of the rays of the beam. Since the imaging properties of the eye are not taken into account in this consideration, this can also be referred to as the focal position in air.

Preferably, the specified focal positions need not be exactly present. By way of example, deviations (e.g., in the propagation direction of the beam) may be present in the region of ±0.5 mm, ±1 mm, ±1.5 mm, ±2 mm, ±2.5 mm, ±3 mm, ±3.5 mm or ±4 mm in air or in the eye.

The illumination optical unit can comprise an optical element with a scattering effect for producing the lateral extent of the focus. The optical element with a scattering effect may comprise a diffusion screen and/or a hologram (e.g., a volume hologram). Further, the optical element with a scattering effect may be embodied in such a way that the scattering effect is only present for the wavelength of the illumination radiation and that there is no scattering effect for light from the visible wavelength range. Thus, the optical element with a scattering effect can be positioned in the normal visual range of the user, for example, as it is not visible to the user.

Further, the optical element with a scattering effect can be positioned closer to an emergence region or an emergence surface of the illumination optical unit (in particular, this is understood to mean the last optical surface of the illumination optical unit influencing the illumination radiation before the latter enters the eye) than at the optical input interface. In particular, the optical element with a scattering effect is formed on the emergence surface or is the last optical element before the emergence surface.

The apparatus can be embodied as an independent optical appliance. In particular, it can be embodied as a separate appliance, in front of which the user positions themselves accordingly. By way of example, the user can sit down in front of the appliance and place their forehead against an abutment surface of the positioning unit, and can then gaze into the appliance, as is conventional for treatment appliances at an ophthalmologist. Additionally, the apparatus can be embodied in such a way that the positioning unit comprises a holding apparatus that can be placed onto the head of a user. This can be a spectacle-like holding apparatus, a helmet or any other apparatus that can be placed onto the head.

In particular, the illumination radiation can have a wavelength outside of the visible wavelength range (which is understood to mean the wavelength range from 400 to 780 nm in this case). In particular, the illumination radiation may lie in the infrared range (e.g., in the range from 780 nm to 50 μm or from 780 nm to 3 μm). Additionally, the illumination radiation may lie in the UV range and thus have a wavelength of less than 400 nm and, more particularly, a wavelength in the range from 200 to 400 nm or from 250 to 400 nm or from 300 to 400 nm, for example.

The wavelength range of the illuminated radiation can be relatively narrowband. In particular, the bandwidth can be 100 nm, 50 nm or 10 nm. Further, the bandwidth can be at least 1 nm, 5 nm or 10 nm. If narrowband-width illumination radiation is present, it may also be part of the visible wavelength range.

Further, an apparatus for supplying energy to and/or communicating with an ocular implant by means of illumination radiation is provided, wherein the apparatus comprises a positioning unit, which sets an illumination position of the eye of a user, an optical input interface, by means of which the illumination radiation is suppliable to the apparatus, and an illumination optical unit, wherein the illumination optical unit focuses the supplied illumination radiation in such a way that, when the eye of the user is in the set illumination position, a virtual focus is present in front of the eye and the illumination radiation enters the eye as a diverging beam.

In particular, the illumination optical unit can be embodied in such a way that the virtual focus has a lateral extent of at least 0.1 mm.

The lateral extent can be 0.2 mm, 0.3 mm, 0.4 mm, 0.5 mm, 0.6 mm, 0.7 mm, 0.8 mm, 0.9 mm, 1.0 mm and up to 3 mm (e.g., in 0.1 mm steps). Further, the lateral extent can be 6 mm to 0.5 mm (e.g., in 0.1 mm steps).

If the apparatus is embodied as a head-wearable apparatus with a spectacle lens, the virtual focus can preferably lie on the side of the spectacle lens facing away from the head (front side).

The apparatus with the illumination optical unit that produces the virtual focus in front of the eye can be developed in the same way as the already above-described apparatus with the illumination optical unit producing the focus in the eye.

It goes without saying that the aforementioned features and those yet to be explained below can be used not only in the combinations specified but also in other combinations or on their own, without departing from the scope of the present invention.

### BRIEF DESCRIPTION OF THE DRAWINGS

The invention is explained in even greater detail below for example with reference to the accompanying drawings, which also disclose features essential to the invention. In the figures:

FIG. 1 shows a schematic perspective illustration of an embodiment of the illumination apparatus according to the invention;

FIG. 2 shows a partial sectional view of the essential optical components for explaining how the implant 2 is illuminated with illumination radiation;

FIG. 3 shows a sectional view of a further embodiment of the illumination optical unit;

FIG. 4 shows a sectional view of a further embodiment of the illumination optical unit;

FIG. 5 shows a sectional view of a further embodiment of the illumination optical unit;

FIG. 6 shows a sectional view of a further embodiment of the illumination optical unit;

FIG. 7 shows a sectional view of a further embodiment of the illumination optical unit;

FIG. 8 shows a sectional view of a further embodiment of the illumination optical unit;

FIGS. 9A and 9B show x- and y-sections of the illumination optical unit in a further embodiment;

FIGS. 10A and 10B show x- and y-sections of the illumination optical unit according to a further embodiment;

FIG. 11 shows a sectional view of a further embodiment of the illumination optical unit;

FIG. 12 shows a plan view of the illumination optical unit of FIG. 11;

FIGS. 13 and 14 show illustrations for explaining the Fresnel structure;

FIG. 15 shows a schematic illustration for explaining the collimation of the illumination radiation;

FIG. 16 shows a schematic illustration for producing an extended light source;

FIG. 17 shows a schematic illustration of a further variant for producing an extended light source;

FIG. 18 shows a sectional illustration of a further embodiment of the illumination optical unit;

FIG. 19 shows a sectional illustration of a further embodiment of the illumination optical unit;

FIG. 20 shows a sectional illustration of a further embodiment of the illumination optical unit;

FIG. 21 shows a sectional illustration of a further embodiment of the illumination optical unit;

FIG. 22 shows a sectional illustration of a further embodiment of the illumination optical unit;

FIG. 23 shows a sectional illustration of a further embodiment of the illumination optical unit;

FIG. 24 shows a sectional illustration of a further embodiment of the illumination optical unit;

FIG. 25 shows a schematic illustration of the illumination optical unit according to a further embodiment;

FIG. 26 shows a schematic illustration of the illumination optical unit according to a further embodiment;

FIG. 27A-D show various rotational positions of the eye in the case of the illumination optical unit according to FIG. 26;

FIG. 28 shows a schematic illustration of the illumination optical unit according to a further embodiment;

FIG. 29A-E show various positions (lateral positions and/or rotational positions) of the eye for the illumination optical unit according to FIG. 28;

FIG. 30 shows a schematic illustration of the illumination optical unit according to a further embodiment;

FIG. 31A-D show various positions (lateral positions and/or rotational positions) of the eye in the case of an illumination optical unit according to FIG. 30;

FIG. 32 shows a schematic illustration of the illumination optical unit according to a further embodiment;

FIG. 33A-D show various positions of the eye in the case of an illumination optical unit according to FIG. 32;

FIG. 34 shows a schematic illustration of the illumination optical unit according to a further embodiment;

FIG. 35A-C show various positions (lateral positions and/or rotational positions) of the eye in the case of an illumination optical unit according to FIG. 34;

FIG. 36A-C show various positions of the eye in the case of a further embodiment of the illumination optical unit, and

FIG. 37 shows a variant of the illumination apparatus according to the invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

Various exemplary embodiments are explained in detail below. These exemplary embodiments serve merely for elucidation and should not be interpreted as restrictive. By way of example, a description of an exemplary embodiment with a multiplicity of elements or components should not be interpreted to the effect that all these elements or components are necessary for implementation purposes. Rather, other exemplary embodiments also may contain alternative elements or components, fewer elements or components or additional elements or components. Elements or components of different exemplary embodiments can be combined with one another, unless indicated otherwise. Modifications and developments which are described for one of the exemplary embodiments may also be applicable to other exemplary embodiments.

In order to avoid repetition, the same elements or corresponding elements in the various figures are denoted by the same reference sign and are not explained a number of times.

A retinal implant is used as an example in the following exemplary embodiments. However, the techniques described are also applicable to other ocular implants, for example the ocular implants mentioned at the outset.

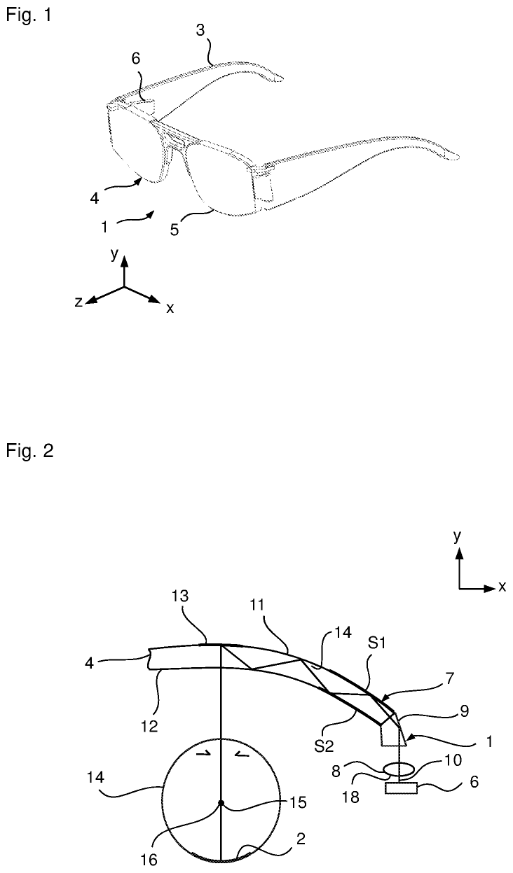

In the case of the embodiment shown in FIGS. 1 and 2, the illumination apparatus 1 according to the invention for supplying an ocular implant 2 (e.g., a retinal implant 2) with energy comprises a holding apparatus 3 that can be placed onto the head of a user and may take the form for example of a conventional spectacle frame, and also a first spectacle lens 4 and a second spectacle lens 5, which are fastened to the holding device 3.

Further, the illumination apparatus 1 comprises a light source 6 which, as is schematically illustrated in FIG. 1, may be arranged on the holding apparatus 3 in the region of the right-hand spectacle earpiece. The light source 6 emits illumination radiation in the infrared range and can be embodied, for example, as an LED or laser.

Further, the illumination apparatus 1 comprises an illumination optical unit 7 comprising a collimation optical unit 8, a deflection prism 9 and the first spectacle lens 4.

The light source 6 emits a diverging beam 10 in the infrared range, which is reshaped into a virtually parallel beam by the collimation optical unit 8. The parallel beam 10 is coupled into the first spectacle lens 4 by means of the deflection prism 9 and then guided in said spectacle lens to an output coupling hologram 13, formed on the front side 11, by means of total-internal reflection at the front side and back side 11, 12 of the first spectacle lens 4. In order to simplify the illustration, only one light ray 10 has been plotted for the beam 10 in FIG. 1. The output coupling hologram 13 deflects the beam 10 in the direction of the back side 12 such that the beam 10 emerges via the back side 12 and strikes the eye 14 of a user wearing the illumination apparatus 1 on their head.

The illumination optical unit 7 and, more particularly, the output coupling hologram 13 bring about focusing of the beam 10 in such a way that the beam 10 strikes the eye 14 or enters the eye 14 as a convergent beam 10. The focus 16 of the beam 10 lies within the eye 14 and, in the embodiment described here, lies at the center of rotation 15 of the eye (without taking account of the refractive power of the eye 14 and consequently in air, as it were). The actual position of the focus 16 is still modified here by the imaging properties of the eye 14. However, the imagined position of the focus 16 is preferably described, said position emerging from the points of intersection of the imagined continuations of the rays of the beam 10. Therefore, the imaging properties of the eye 14 are not taken into account in this consideration, and so this can also be referred to as the focal position in air.

The illumination optical unit 7 is designed in such a way that the focus 16 is a spatially extended focal spot 16 that has a lateral extent (in particular, this is understood to mean the extent transverse to the propagation direction of the beam and consequently in a plane perpendicular to the plane of the drawing in FIG. 2, which contains the x-axis according to FIG. 2) of at least 0.1 mm. By way of example, these minimum dimensions of the focus 16 can be achieved by a scattering function brought about by the output coupling hologram 13. Once again, the specified minimum dimension of the focus 16 relates to the size of the focus in the air (i.e., without taking account of the refractive power of the eye 14).

The focus 16 need not lie exactly at the center of rotation 15. In the propagation direction of the beam 10 (and consequently the y-direction here), it can lie in a region of ±5 mm, ±4 mm, ±3 mm, ±2 mm or ±1 mm around the center of rotation 15.

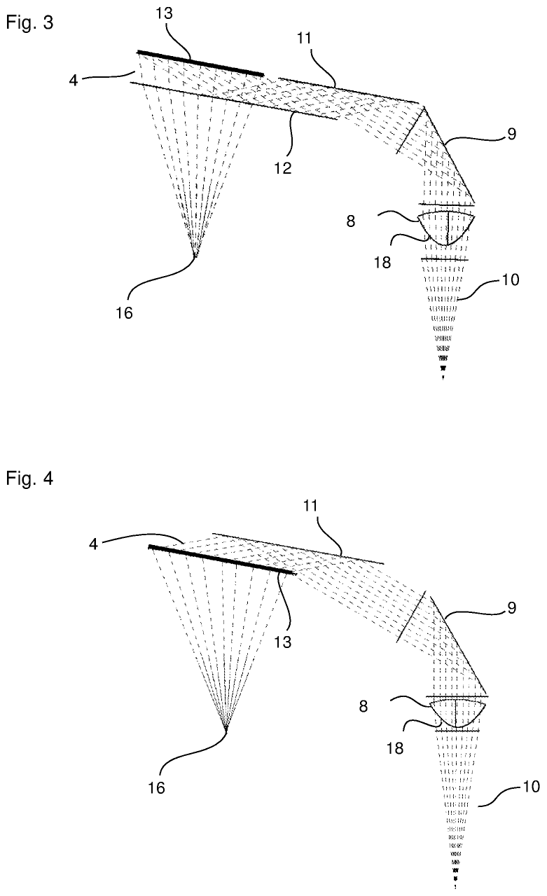

In a similar illustration to FIG. 2, FIG. 3 illustrates the entire beam 10, and so it is clearly evident how the diverging beam 10 is converted into a collimated beam 10 by means of the collimation optical unit 8, said beam then being input coupled into the spectacle lens 4 by the deflection prism 9 and being guided in said spectacle lens to the output coupling hologram 13 such that the described focus 16 is produced on account of the reflection at the output coupling hologram 13. The front side 11 and back side 12 of the spectacle lens 4 are embodied as plane surfaces in the illustration of FIG. 3. However, it is also possible for the front and back side 11, 12 to have a curved embodiment, as shown in FIG. 2. In the embodiment according to FIGS. 2 and 3, the hologram 13 can be embodied as a reflective hologram.

However, the hologram 13 can also be embodied as a transmissive hologram. In this case, the hologram 13 is arranged on the back side 12, as illustrated schematically in FIG. 4.

The side 18 of the collimation optical unit 18 on which the diverging beam 10 strikes can also be referred to as input interface 18 of the illumination optical unit 7.

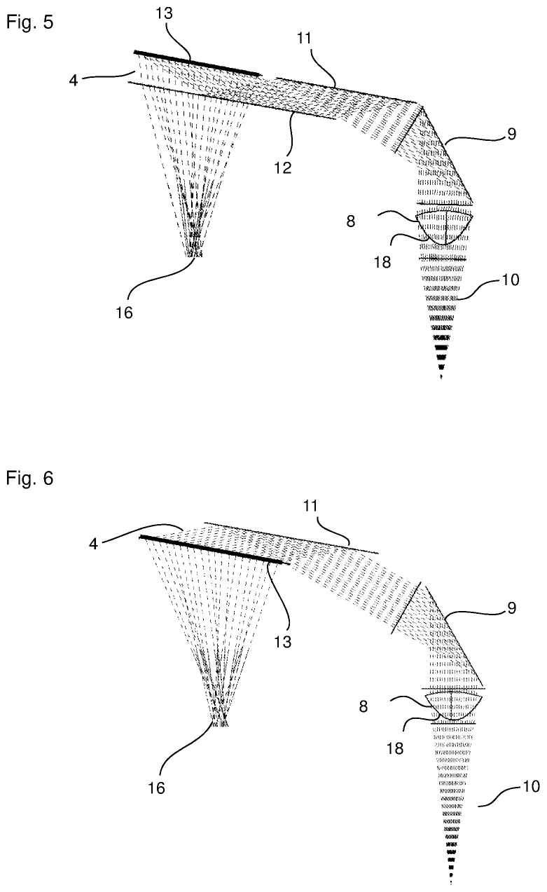

FIG. 5 shows a modification of the embodiment according to FIG. 3. In the embodiment of FIG. 5, the scattering properties of the output coupling hologram 13 are increased, and so the focus 16 has a greater lateral extent in comparison with the embodiment according to FIG. 3.

The same applies to the modification of the embodiment of the illumination apparatus 1 according to FIG. 4, which is shown in FIG. 6.

In particular, the output coupling hologram 13 is embodied as a volume hologram. The embodiment as a hologram leads to the advantage that a gaze therethrough in relation to the light from the visible wavelength range is unperturbed for the user. Particularly in the case of the embodiment as a volume hologram, the high selectivity of the deflection reflection in respect of the wavelength of the incident radiation and in respect of the angle of incidence can be used to ensure that the specified gaze therethrough for light from the visible wavelength range is unperturbed. Away from the so-called Bragg condition, which links the efficient angle of incidence and the efficient wavelength, the hologram 13 is transparent and without any further optical function.

Preferably, the eye-side numerical aperture of the illumination optical unit 7 lies in the range between 0.1 and 0.5 and, particularly preferably, in the range between 0.25 and 0.4. The focus 16 can be circular. The diameter D of the focus 16 preferably lies in the range of greater than or equal to 0.1 mm and less than or equal to 10 mm, or greater than or equal to 1 mm and less than or equal to 10 mm. More particularly, the diameter D is preferably 1 mm≤D 10 mm or 2 mm≤D≤5 mm. Naturally, the form of the focus 16 can be not only circular but can also have a form that deviates from the circular form. By way of example, an elliptic, a rectangular, a square or any other form may be present. In this case, the specified diameter values relate to the smallest circle in which the focus 16 with the form deviating from the circular form is completely contained.

The energy offered in the focus 16 can preferably lie in the range between 1 mW and 200 mW and particularly preferably in the range between 10 mW and 100 mW. The exact dimensioning can be implemented taking into account the energy requirements of the implant 2, the biological limits and the angle of rotation of the eye expedient for the user.

The spacing between focus 16 and spectacle lens 4 preferably lies in a range between 12 mm and 35 mm and particularly preferably in a range between 23 mm and 27 mm.

The thickness of the spectacle lens preferably lies in a range between 1 mm and 10 mm and particularly preferably in a range between 3 mm and 5 mm. The angle of incidence of the rays in the interior of the spectacle lens 4 preferably lies between 45° and 80° and particularly preferably between 60° and 75°. In the case of a given numerical aperture, the two variables depend on one another since the incident light 10 should not strike the hologram 13 twice. The spectacle lens 4 tends to be able to have a thinner design in the case of large angles of incidence in the spectacle lens 4; a thicker spectacle lens 4 is required for shallower angles of incidence.

The number of total-internal reflections in the interior of the spectacle lens 4 can vary, preferably between one total-internal reflection and five total-internal reflections. For the particularly preferred distances, angles and head geometries, two reflections in the case of a reflection hologram and one reflection in the case of a transmission hologram are particularly preferred.

Reflective layers S1, S2 (FIG. 2) that bring about the desired reflection could also be formed on the front and/or back side 11, 12; this could be implemented instead of total-internal reflections. The reflective layer or the reflective layers could also be spaced apart from the front side 11 or from the back side 12 and consequently have an embodiment buried in the spectacle lens 4.

The refractive index of the material for the spectacle lens 4 preferably lies in the vicinity of, or slightly above, the refractive index of the material used to record the hologram 13. Therefore, the refractive index preferably lies in the range between 1.4 and 1.6 and, particularly preferably, in the range between 1.48 and 1.55. The reflection losses at the interface become too large if the refractive index difference in relation to the hologram material is too large. If the refractive index of the substrate is greater than that of the film of the hologram 13, total-internal reflection may occur at the interface. Moreover, the light 10 then has grazing incidence in the interior of the hologram film, making the technical realization of the hologram 13 more difficult.

The material of the spectacle substrate can be an optical glass or an optical plastic, provided the respective transmission thereof is sufficiently high for the considered illumination wavelength. Plastics are preferred on account of their low weight. Possible materials include PMMA, polycarbonate, Zeonex or CR39, for example.

The light source 6 preferably makes light in the infrared range available. More particularly, the light source 6 can make light outside of the visible spectral range available. Particularly preferably, this is a narrowband, coherent laser light 10 with a full width at half maximum of less than 10 nm. The lateral extent of the light source 6, and consequently the lateral extent of the emitted light beams, is small, for example preferably less than 100 μm, e.g., in the range of 5 to μm. Particularly preferably, this is a single mode laser source 6.

The output coupling efficiency of the hologram 13 drops for wavelengths away from the peak maximum if the full width at half maximum of the spectral emission of the light source 6 is significantly larger. If the lateral extent of the source 6 exceeds a certain size that depends on the focal length of the collimation optical unit 8, there likewise is a drop in the output coupling efficiency because the hologram 13 can only efficiently deflect a finite angle range of incident radiation 10.

Further, the light source 6 particularly preferably has a fast and a slow axis; i.e., the divergence of the offered radiation has different values for different azimuths (x and y). This is the case for commercially available single mode semiconductor lasers. The divergences preferably differ by a factor of 1.5 to 4. A projection effect is inherent in the hologram-based output coupling, said projection effect, without a further optical component, converting this divergence difference after the output coupling into a rotationally symmetric and consequently preferred angle distribution at the eye 14 depending on the employed angle of incidence.

The projection factor is the cosine of the angle of incidence at the hologram 13; i.e., it is approximately 0.5 in the case of an angle of incidence of 60° and it is approximately 0.26 in the case of an angle of incidence of 75°. As a result, a divergence difference between a factor of 2 to 4 is compensated.

Although this is not mandatory, the light source 6 preferably emits linearly polarized illumination radiation 10. Particularly preferably, the linear polarization lies perpendicular to the plane that spans the slow (short) axis of the diode 6. A typical volume hologram 13 is particularly efficient for this polarization. If the polarization is perpendicular to this preferred axis, as is the case for laser diodes 6 made available by technology, a retardation plate or film (λ/2 plate, not shown) can be introduced along the beam path according to the invention, said retardation plate or film rotating the polarization direction after the passage through the retardation plate or film. The retardation plate or film is preferably introduced in the region of the collimated beam 10, i.e., for example, prior to input coupling in the spectacle lens 4 or prior to the output coupling by the hologram 13.

According to the invention, a retardation element with arbitrary phase shift and orientation (λ/4 plate or λ/x plate) and combinations of various such elements can also be introduced instead of λ/2 plate. These are preferably used if the collimation optical unit inexpediently influences the polarization state of the beam. Then, an opposite compensation is brought about with the aid of the suitable retardation element.

There are various solutions for the design of the collimation optical unit 8, for example by way of refractive elements, more particularly round-optical, refractive elements (spherical lenses, aspheres), by way of reflective elements or collimation mirrors (with a spherical, aspherical or free-form element-type embodiment) and/or by way of diffractive elements. The deflection of the collimated light 10 from the direction of the spectacle earpiece into the spectacle lens 4 can be obtained by mirrors, by deflection prisms (as shown) or by diffractive elements.

As a rule, the emission characteristic of the light source 6, i.e., the angle distribution of the power emitted by the light source 6, has a finite full width at half maximum for commercially available diodes. This means that the power emitted in a spatial direction decreases with increasing angle. According to the invention, the focal length of the collimation optical unit 8 is preferably adapted in such a way that the outer rays guided in the spectacle lens 4 still transfer a certain amount of power per unit area. In the case of a short focal length, much of the offered light is collected by the collimation optical unit 8; however, the outer rays in the beam contribute to the overall energy with significantly less power per unit area. In the case of a long focal length, the power distribution is significantly more homogenous over the beam cross-section; however, a greater part of the offered energy is not transferred.

According to the invention, the focal length can be chosen in such a way that the edge drop-off lies in the range of 50% and 10% of the luminous intensity of the beam center.

Should the projection factor of the output coupling hologram 13 not correspond sufficiently closely to the divergence difference of the diode axes when the thickness of the spectacle lens 4 is set and when the angle of incidence is set, the collimation optical unit 8 could have an anamorphic configuration (i.e., with different focal lengths in the x- and y-sections). By way of example, this can be implemented by the introduction of refractive, diffractive and/or reflective cylindrical surfaces.

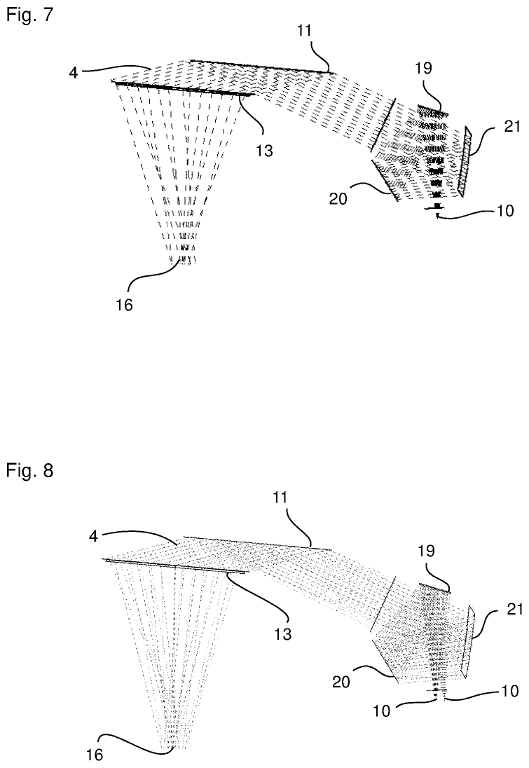

The focal lengths, and hence installation lengths, of the collimation optical unit 8 resulting for the aforementioned conditions may be very long under certain circumstances, i.e., greater than 20 mm, for example. It is therefore advantageous to fold these in compact fashion in order to integrate them in a spectacle frame in space-saving fashion. However, in the case of a solution in the form of a mirroring collimation optical unit 8, the angles of incidence at the imaging mirror should not become too large. Particularly preferred folding of the collimation optical unit 8 is shown in FIG. 7. In the case of the folding shown, the beam 10 of the light source 6 is incident on a first mirror 19, embodied as a cylindrical surface, and reflected by the latter onto a second mirror 20, which has a plane embodiment. The beam 10 is reflected from the second mirror 20 to the third mirror 21, which is embodied as a free-form mirror or as an aspherical, rotationally symmetric surface used in off axis fashion, and then coupled into the spectacle lens 4 by the latter. Consequently, the deflection prism 9 can be omitted in this embodiment. As may be gathered from the illustration of FIG. 7, the output coupling hologram 13 is embodied as a transmissive hologram on the back side 12.

As a result of the folding with the three mirrors 19-21, the angle of incidence at the free-form mirror 21 can be less than 25° and a focal length in the range of, e.g., 20 mm and 40 mm can be realized, despite the compact structure. The aforementioned divergence correction is achieved by means of the first mirror 19, which is embodied as a cylindrical surface.

In further exemplary embodiments, all or optionally additional effective surfaces of the collimation optical unit may also have other, i.e., arbitrary, combinations of the aforementioned surface forms, i.e., plane surfaces, spherical surfaces, cylindrical surfaces, toric surfaces, rotationally symmetric aspherical surfaces, aspherical surfaces used in off axis fashion or free-form surfaces. Moreover, further imaging functions could optionally be applied to the effective surfaces, for example diffractive elements (gratings, volume holograms) or Fresnel elements. The selection of the suitable combination depends on the specifications of the chosen light source.

The most efficient angle of incidence (Bragg condition) of the hologram 13 may vary on account of production-related tolerances when exposing the hologram 13. Likewise, the peak wavelength of the light source 6 may vary from component to component. The collimation optical unit 8 is embodied for a small field in order to obtain an efficient output coupling structure (output coupling hologram 13 in this case) for a useful wavelength range and for sensible manufacturing tolerances. Consequently, the light source 6 can be laterally displaced in the illumination apparatus 1 according to the invention, as a result of which it is possible to change the mean angle of incidence of the rays on the hologram 13. This is shown schematically in FIG. 8 for two different positions of the light source 6, with, however, only the diverging beam emitted by the light source 6 always being plotted in each case.

In particular, the collimation optical unit 8 can have such a design that variations of the angle of incidence over the entire employed beam 10 are preferably less than 1° and particularly preferably less than 0.1°. Preferably, the lateral displacement should cover an adjustment range of ±5° at the output coupling hologram 13 and more particularly cover an adjustment range of ±1° at the output coupling hologram 13.

Alternatively, the angle of incidence can also be adapted by the targeted tilting of the collimation optical unit relative to the spectacle lens and the subsequent fixation thereof. By way of example, this angle manipulation can be implemented by a variable cemented wedge between both cemented or adhesively bonded elements, by variable prism wedges, adjustable deflection mirrors or similar optical principles.

Further, the collimation optical unit 8 can be designed for small axial deviations; i.e., the light source 6 can also be displaced along the direction of the emitted beam 10 for compensating manufacturing-related tolerances in order to maximize the overall efficiency of the output coupling hologram 13.

An advantage of the described solution with the collimated beam 10 lies in the fact that the illumination optical unit 7 can be fitted onto different head widths of users without losses in the efficiency by way of different distances between the spectacle lens 4 and the collimation optical unit 8. The different distances are adjustable in the illumination apparatus 1 according to the invention. The user can carry out the adaptation for different pupil distances by a lateral displacement of the entire illumination optical unit 7 relative to the head or eye 14 of the user.

A particular advantage of the volume-holographic illumination optical unit 7 consists in the fact that a scattering function can be introduced into the output coupling hologram 13 in addition to the focusing function. By way of example, this can be realized by virtue of the fact that one of the two waves is influenced during the exposure by a targeted static beam deflection by means of introduction of a diffusion screen. As a result, a high etendue (product of numerical aperture and light spot diameter) can only be produced very close to the eye. This means that the transfer within the spectacle lens 4 can still be implemented as a single beam 10 of a point source. Only the last optically effective surface (the output coupling hologram 13 in this case) increases the etendue to the desired size by scattering. This reduces the technical outlay in comparison with solutions which image the image of a luminous area that is already extended at the source 6 into the center of rotation 15 of the eye 14.

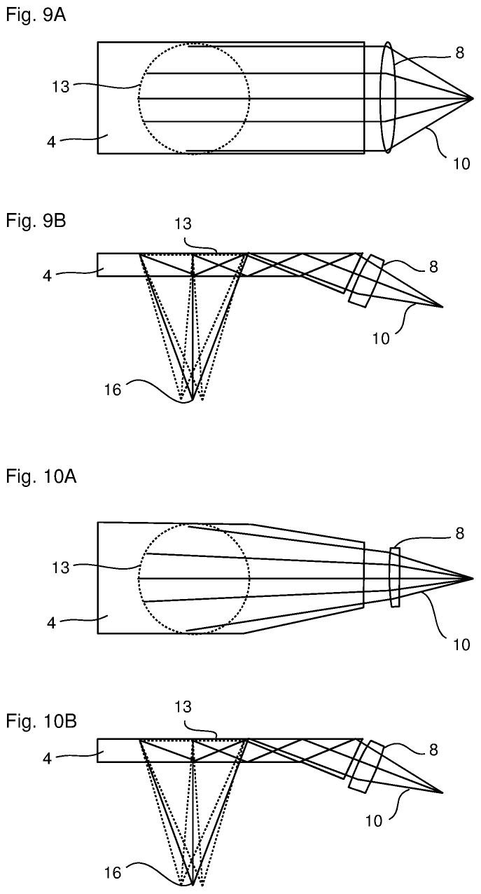

If the adaptation to different head widths of users is implemented not by way of the illumination optical unit 7 but, e.g., purely mechanically, there can be a deviation from the strict collimation in the interior of the spectacle lens 4. Then, a divergent beam profile in one of the two azimuths is also possible. Then, the collimation optical unit 8 is for example no longer rotationally symmetric but instead defined defocused in one of the two azimuths (x- or y-section). The rotationally symmetric case is schematically illustrated in FIGS. 9a and 9b. By contrast, the aforementioned defined defocused case is shown in FIGS. 10a and 10b. The advantage of this configuration lies in a narrow beam geometry in the region of the spectacle earpiece. This makes it more easily possible to design the spectacles or the holding apparatus 3 to be aesthetically more similar to conventional spectacles. The embodiments described until now can be characterized as a non-telecentric illumination with a scattering function, which is only implemented close to the eye prior to the emergence of the beam 10 from the spectacle lens 4. A volume hologram 13 is not mandatory to this end. A similar technical implementation can be realized using a surface grating with a special dichroic coating and a statistical modification. Also, provision can be made of a statistically modified Fresnel lens with structuring in the sub-millimeter range, or a corresponding Fresnel mirror. So as to ensure the function of allowing a gaze to pass, the Fresnel structure of the lens or of the mirror should have a dichroic coating and should be buried in the material of the spectacle lens 6. This means that the flanks are preferably filled with a material that has been sufficiently adapted in terms of refractive index such that the front side 11 or the back side 12, for example, has an embodiment with a continuously smooth surface despite the Fresnel structure.

Advantages of the volume hologram 13 lie in the simple technological implementation, e.g., as a film, and in high achievable deflection efficiency.

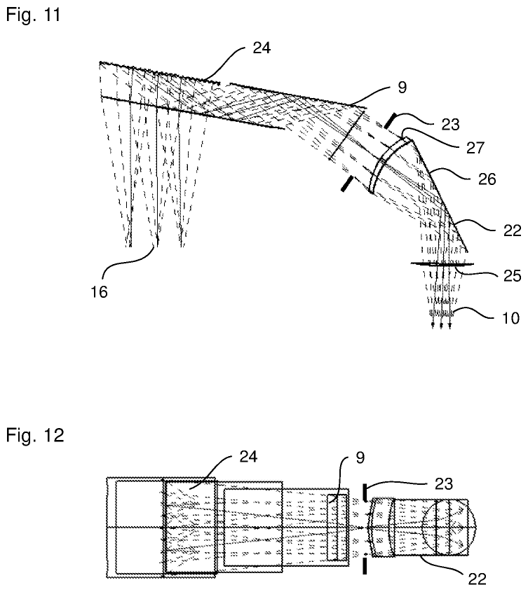

FIGS. 11 and 12 show a further embodiment of the illumination apparatus 1 according to the invention, in which the light source 6 is a light source 6 with a lateral extent and consequently emits a diverging beam 10 with a lateral extent. Disposed downstream of the light source 6 are, in this sequence, an imaging optical unit 22, a telecentricity stop 23, the deflection prism 9 and the first spectacle lens 4. Instead of the output coupling hologram, the first spectacle lens 4 has a Fresnel element 24, yet to be described in more detail below, in the embodiment described here.

The luminous surface of the light source 6 is imaged a certain distance into the spectacle lens 4 by the imaging optical unit 22. In so doing, the light 4 is guided by total-internal reflection in the interior of the spectacle lens 4 and finally deflected by the Fresnel element 24 in such a way that it leaves the total-internal reflection and emerges from the spectacle lens 4. Then, the arising image of the light source 6 is situated in the eye 14 at a defined distance from the spectacle lens 4 and preferably situated, e.g., in the plane of the pupil of the eye 14 or in the center of rotation 15 of the eye 14. It may also be close to these positions. In particular, this is understood to mean a distance in the propagation direction of the beam of ±5 mm, ±4 mm, ±3 mm, ±2 mm or ±1 mm relative to these positions.

As is evident from FIG. 11, in particular, the imaging optical unit 22 as an input surface 25 may have a spherical surface, a cylindrical surface or a free-form surface. The input surface 25 can also be referred to as optical input interface of the illumination optical unit 7.

A plane deflection surface 26 is disposed downstream of the input surface 25 and the imaging optical unit 22 has a cylinder or free-form surface as an emergence surface 27.

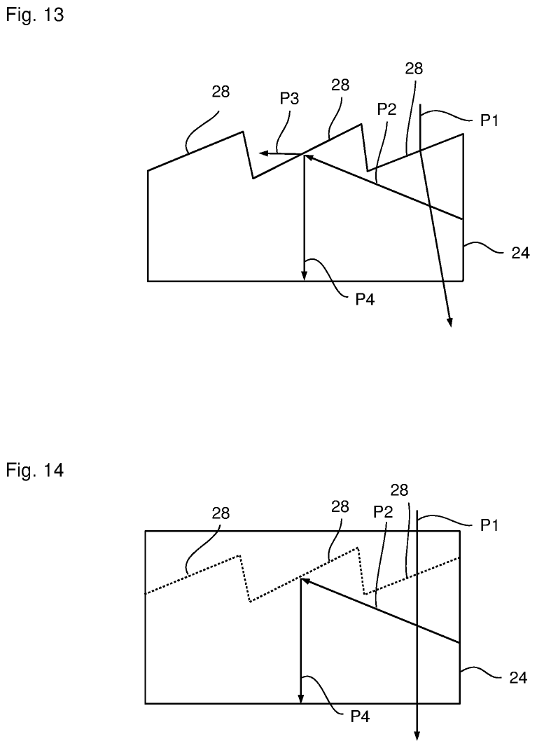

As is evident from the magnified detailed view of the Fresnel element in FIG. 13, the Fresnel element 24 may have uncoated, exposed Fresnel flanks 28. However, this leads to a disturbance in the direction of the gaze therethrough, as indicated by the arrow P1. Additionally, the efficiency of the deflection is relatively low, as indicated by the arrows P2, P3 and P4.

FIG. 14 shows a modification of the Fresnel element 24. The Fresnel flanks 28 are coated in dichroic fashion in this modification. What this can achieve is that the wavelength required for illuminating the implant 2 is reflected to a sufficiently large extent, as indicated by the arrows P2 and P4. By way of example, the sufficiently large extent can be greater than or equal to 50%. By contrast, the visible spectral range or at least parts thereof are transmitted to sufficiently large extent, as indicated by the arrow P1. The sufficiently large extent can be, e.g., greater than or equal to 50%. Moreover, the Fresnel structure labeled in FIG. 14 is buried; i.e., the optically effective, dichroic Fresnel flanks 28 are filled with material that has the same or approximately the same refractive index in the visible spectral range as the remaining material of the spectacle lens 4. By way of example, the differences in the refractive indices can be less than or equal to 0.01 (for the wavelength range of interest here for the gaze therethrough).

By way of example, the Fresnel element 24 can be described as a height profile, the basic form of which is represented by a sum of x-y polynomials.

$${z}_{G} ( x , y ) = {\sum }_{i , j} {a}_{i j} {x}^{i} {y}^{j}$$

However, this should not be understood to be restrictive. Rather, all further representations of free-form surfaces are naturally also possible.

If the sag z_{G} exceeds a flank height h_{F} defined in advance, the profile form is reduced by an integer multiple of this flank height until the modified sag once again falls in the interval [0 . . . h_{F}] or [−h_{F} . . . 0].

The first two terms of the polynomial a₁₀x+a₀₁y describe an inclined plane. Therefore, according to the invention, the two parameters a₁₀ and a₀₁ are chosen in such a way that a defined angle of incidence of the chief ray of the axial beam is set within the spectacle lens 4. Total-internal reflection is no longer possible if the angle of incidence of the rays 10 in the spectacle lens 4 is too small. If the angle of incidence is too large, the shadowed regions between the Fresnel flanks 28 increase and the sensitivity to the manufacturing tolerances of the Fresnel element 24 and of the spectacle lens 4 moreover increases.

Therefore, the angle of incidence of the rays 10 in the interior of the spectacle lens 4 preferably lies between 45° and 85° and particularly preferably between 60° and 75°. Therefore, the coefficients lie in the range of 0.4<|a₀₁, a₁₀|<0.9 for conventional spectacle lens refractive indices.

The thickness of the spectacle lens 4 can be chosen in such a way that, in the case of an imagined propagation of the light in the reverse direction, i.e., from the eye 14 to the light source 6, the light does not strike the Fresnel element 24 again after reflection at the Fresnel element 24 and after a further total-internal reflection at the back side 12 lying opposite the Fresnel element 24. The spectacle lens 4 tends to be able to have a thinner design in the case of large angles of incidence in the spectacle lens 4. A thicker spectacle lens 4 is required for small angles of incidence. The thickness of the spectacle lens 4 preferably lies between 1 mm and 10 mm and particularly preferably between 3 mm and 5 mm.

The next two terms of the polynomial a₂₀x²+a₀₂y² describe a parabolic surface possibly with different curvatures in the two azimuths, i.e., the paraxial refractive power of the surface in the x- and y-section. These terms can be chosen in such a way that the front, i.e., eye-distant, focus of the surface is situated on, or at least in the vicinity of, an aperture stop attached at the entrance into the spectacle lens 4. In this plane, axially parallel rays, which strike the spectacle lens 4 from the side of the eye, intersect both in the x-section and in the y-section. These rays are plotted in continuous fashion in FIG. 12.

In this way, the aperture stop applied there becomes a telecentricity stop; i.e., the arrangement ensures a telecentric illumination of the eye 14. As a result of the oblique incidence on the Fresnel element 24, the two refractive powers, i.e., the two coefficients a₂₀ and a₀₂, too, have different magnitudes in the x- and y-section. According to the invention, the two coefficients lie in the range of 0.001<|a₂₀, a₀₂|<0.05 for conventional spectacle geometries.

The form of the telecentricity stop 23 can be arbitrary. Preferably, it is circular, ellipsoid, square or rectangular.

The further coefficients of the surface can be used for improving the stop imaging or they are optimized for reducing the aberrations of the imaging light source 6. In practice, the design will mediate between two requirements, depending on the requirement of the specific application.

The flank height h_{F} of the Fresnel flanks 28 preferably lies in the range between 0.02 mm<h_{F}<1 mm. Heights of the Fresnel flanks 28 that are too low disturb the imaging on account of possible diffraction effects. Heights of the Fresnel flanks 28 that are too high can be visible as a disturbing modulation of the illumination distribution.

Preferably, the eye-side numerical aperture lies in the range between 0.05 and 0.5, particularly preferably in the range between 0.1 and 0.25. The diameter D of the image 16 of the light source 6 on the eye is preferably 0.1 mm<D<15 mm, in particular 1 mm<D<15 mm and particularly preferably 2 mm<D<10 mm. The diameter D describes the diameter of a circular image 16. Should the image 16 not be circular, it describes the diameter of the smallest circle in which the image 16 is completely contained.

The form of the light spot 16 or the image 16 can be circular, elliptical, rectangular, square or any other form, which can be realized by a light source or diffusion screen made available by technology. The energy offered in the focus 16 preferably lies in the range between 1 mW and 200 mW and particularly preferably between 10 mW and 100 mW. The exact dimensioning can be implemented taking into account the energy requirements of the implant 2, the biological limits and the angle of rotation of the eye expedient for the wearer.

For the illumination configuration described here, the light focus 16 preferably has a distance from the spectacle lens 4 of between 10 mm and 25 mm and particularly preferably a distance of between 12 mm and 20 mm.

Further, the light focus 16 can have a distance from the spectacle lens 4 of between 12 mm and 35 mm and particularly preferably a distance of between 23 mm and 27 mm.

The number of total-internal reflections in the interior of the spectacle lens 4 can vary, preferably between one total-internal reflection and five total-internal reflections.

The refractive index of the substrate of the spectacle lens 4 is not ostensibly decisive for the function for as long as the condition of total-internal reflection in the interior is met. Therefore, transparent substrates with a high refractive index of greater than 1.4 and, in particular, greater than 1.6 are preferred. If the light guidance in the spectacle lens 4 is not implemented by total-internal reflection but by way of reflective layers situated on the front and/or back side 11, 12 or at a distance from the front and/or back side 11, 12, the refractive index has no influence on the light guidance in the spectacle lens 4.

The material of the spectacle lens 4 can be an optical glass or an optical plastic, provided the respective transmission thereof is sufficiently high for the considered illumination wavelength. Plastics are preferred on account of their low weight. Possible materials include PMMA, polycarbonate, Zeonex or CR39, for example.

A significantly improved imaging performance is achieved in comparison with a similar solution on the basis of an imaging diffractive structure (e.g., surface grating or volume hologram) as a result of the deflection by means of the Fresnel element 24. Large aberrations, which restrict the function of the illumination system 1, arise for systems based on a diffractive output coupling element when imaging large fields and large numerical apertures. The aberrations arise since the imaging equation has a strong nonlinearity for the diffractive deflection at high angles of incidence when compared with the deflection by a mirroring Fresnel surface 28.

Preferably, the refractive powers of the Fresnel surface 28 have different magnitudes in the x- and y-section. In order to produce a real image of the light source 6 in the focus 16 of a predetermined plane close to the eye, the foci of the virtual image of the light source 6 in the interior of the spectacle lens 4 must likewise have a suitable difference in the x- and y-section; i.e., they must be suitably offered to the Fresnel surface 28. Therefore, the source-side imaging optical unit must likewise have different refractive powers in the x- and y-sections such that beams 10 starting at the light source 6 receive the required focus offset between the two azimuths.

Therefore, the source-side imaging optical unit 22 comprises at least one surface with different refractive powers in the x- and y-section. By way of example, this can be realized by a cylindrical surface, a free-form surface with different cylindrical components or a spherical or aspherical surface used off axis. In the embodiment described here, this is realized both at the input surface 25 and at the emergence surface 27.

As a result, the imaging scale between the extended light source 6 and the image 16 of the light source 6 at the eye 14 has different values in the x- and y-section. By way of example, a circular image of the light source 6 at the eye 14 then requires an elliptical source; a square image requires a corresponding rectangular source 6. The main cause for this difference lies in the projection effect—similar to the variant with the volume hologram—that arises at the Fresnel surface 24.

The specific form can be achieved either by a targeted design of the source 6, i.e., the luminous material already has this form, or by shadowing a larger source 6 by a stop. The former is technically complicated, the latter leads to high light losses.

However, the use of an efficient laser source 6, the lateral extent of which however is very small, is particularly preferred. The desired extent can then be achieved using a diffusion screen. According to the invention, the projection effect is exploited in a targeted fashion in this case; i.e., a semiconductor laser diode 6 with a slow and a fast axis is used (i.e., the divergence angle of the radiation 10 emerging from the source has different magnitudes along two axes that are perpendicular to one another and perpendicular to the propagation direction). As a rule, sources 6 made available by technology have this effect. If the beam 10 of such a source, as shown schematically in FIG. 15, is collimated by a simple rotationally symmetric optical unit 8, the desired elliptical area arises.

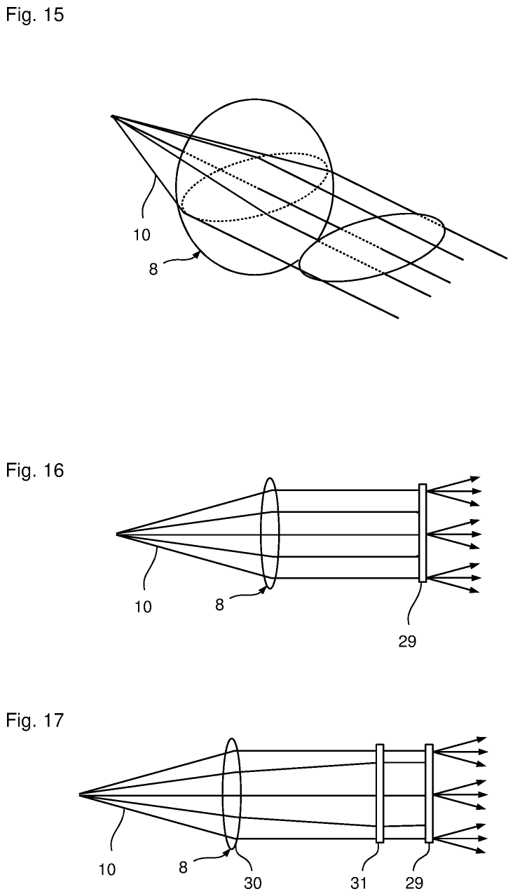

As indicated schematically in FIG. 16, the beam 10 can be converted by a diffusion screen 29 into an extended light source, the emission characteristic of which can still be modified as well. Alternatively, as shown in FIG. 17, an asphere 30 for redistributing light, a weak free-form surface 31 and a diffusion screen 29 can be disposed in this order downstream of the light source 6 that emits the beam 10 in order to provide the desired extended light source.

The divergences of the laser source 6 preferably differ by a factor of 1.5 to 4. The light source 6 preferably provides light outside of the visible spectral range, particularly preferably narrowband light with a full width at half maximum of less than 50 nm.

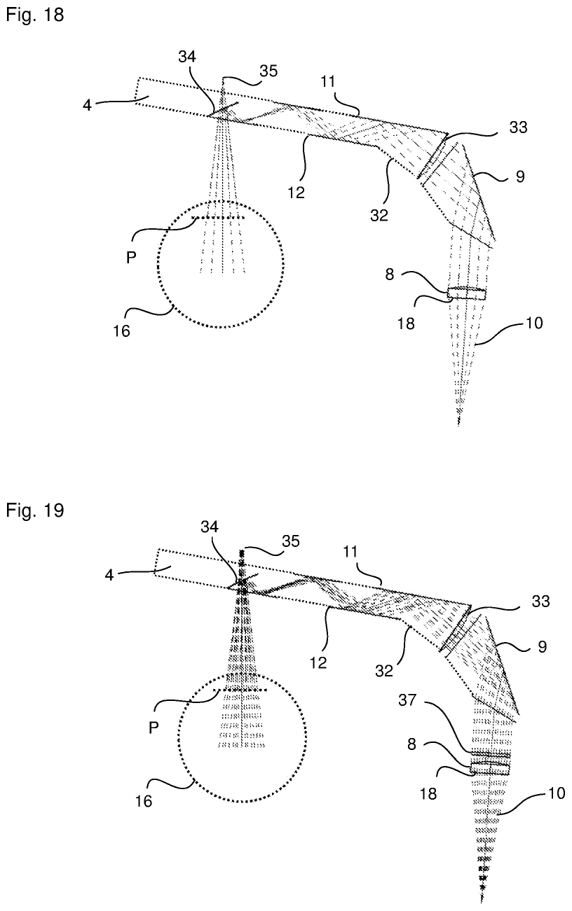

FIG. 18 shows a further embodiment of the illumination apparatus 1 according to the invention. The illumination apparatus 1 comprises a light source 6, a collimation optical unit 8, a deflection prism 9, an input coupling prism 32 with an imaging surface 33, a spectacle lens 4 and a dichroic splitter layer 34 buried in the spectacle lens 4. The diverging radiation 10 of the light source 6 is reshaped into a virtually parallel beam 10 by the collimation optical unit 8 and then deflected in the direction of the spectacle lens 4 by the deflection prism 9, said spectacle lens comprising the input coupling prism 32 with imaging surface 33 and consequently leading to the beam 10 being focused into the spectacle lens 4; the beam is guided in said spectacle lens by total-internal reflection and finally steered in the direction toward the eye 14 by the buried dichroic splitter layer 34.

In order to permit a gaze therethrough that is as undisturbed as possible, the splitter layer 34 preferably has a dichroic coating; i.e., the wavelength range required for illuminating the implant 2 is reflected to a sufficiently large extent (e.g., greater than 50%). By contrast, the visible spectral range or at least parts thereof are transmitted to sufficiently large extent (e.g., 50%).

The splitter layer 34 is buried in the spectacle lens 4 for the same reason; i.e., the optically effective surface of the splitter layer 34 is situated in the interior of the spectacle lens 4, embedded between two media that have the same or approximately the same refractive index in the visible spectral range. By way of example, the difference in the refractive indices before and after the splitter layer is less than 0.01.

The buried splitter layer 34, which can also be referred to as the buried mirror 34, is preferably embodied as an imaging splitter layer 34 or as an imaging mirror 34. In the simplest case, the splitter layer 34 has a spherical form. However, it may also have be of aspherical form or may be embodied as a free-form mirror. The imaging function of the splitter layer 34 is used to reduce the required free diameter on the input coupling side. If the imaging function is dispensed with, it is necessary either to restrict the divergence of the virtual focus 35 and/or the adjustment range of the focus, or to use an optical unit requiring more installation space on the input coupling side, as shown in U.S. Pat. No. 9,479,902 B2.

The splitter layer 34 preferably has a concave curvature toward the eye or toward the back side 12. The radius of curvature preferably lies between 25 mm and 200 mm, particularly preferably between 45 mm and 75 mm.

The deflection angle of the output coupling mirror 34 is preferably chosen in such a way that all rays are guided in the interior of the spectacle lens 4 by total-internal reflection. Total-internal reflection is no longer possible if the angle of incidence of the rays in the spectacle lens 4 is too small. The sensitivity of the system to manufacturing tolerances of the spectacle lens 4 increases if the angle of incidence is too large.

Therefore, the angle of incidence of the rays of the spectacle lens 4 preferably lies between 45° and 85°, particularly preferably between 60° and 70°. Therefore, the angle of inclination of the mirror 41 lies between 22.5° degrees and 42.5°.

The spectacle lens 4 tends to be able to have a thinner design in the case of large angles of incidence in the spectacle lens 4; a thicker spectacle lens 4 is required for shallow angles of incidence. The thickness of the spectacle lens 4 preferably lies between 1 mm and 10 mm and particularly preferably between 3 mm and 5 mm.

Preferably, the eye-side numerical aperture lies in the range between 0.02 and 0.2 and particularly preferably in the range between 0.05 and 0.15. The lateral adjustment range of the virtual focus 35 preferably lies between ±0.5 mm and ±5 mm.

The energy offered in the virtual light focus 35 preferably lies in the range between 1 mW and 200 mW, particularly preferably between 10 mW and 100 mW. The exact dimensioning can be implemented taking into account the energy requirements of the implant 2, the biological limits and the angle of rotation of the eye expedient for the wearer.

The eye pupil of the eye 14 preferably has a distance from the spectacle lens 4 of between 10 mm and 25 mm, particularly preferably a distance of between 12 mm and 20 mm.

The virtual light focus 35 preferably has a distance from the eye pupil of the eye 14 of between 15 mm and 50 mm, particularly preferably a distance of between 20 mm and 30 mm.

The number of total-internal reflections in the interior of the spectacle lens can vary, preferably between one total-internal reflection and ten total-internal reflections.

The refractive index of the substrate of the spectacle lens 4 is not ostensibly decisive for the function for as long as the conditions of total-internal reflection in the interior are still met. Therefore, transparent substrates with a refractive index of greater than 1.4 and particularly preferably greater than 1.6 are preferred. If the light guidance in the spectacle lens 4 is not implemented by total-internal reflection but on account of reflective layers provided on the front and/or back side 11, 12 or at a distance from the front and/or back side 11, 12, the refractive index can be chosen freely in respect of the light guidance.

The material of the spectacle substrate can be an optical glass or an optical plastic, provided the respective transmission is sufficiently high for the considered illumination wavelength. Plastics are preferred on account of their low weight. Possible materials include PMMA, polycarbonate, Zeonex or CR39, for example.

An efficient laser source is a preferred light source 6. Semiconductor laser diodes 6 made available by technology have different divergence angles for different azimuths of the radiation emerging from the source 6. In order to compensate this effect, a fast-axis collimator (not shown) can be used downstream of the laser source 6.

The light source 6 preferably makes light outside of the visible spectral range available. Narrowband light with a full width at half maximum of less than 50 nm is particularly preferred.

Narrowband and polarized light simplifies the production of the buried dichroic splitter layer on the output coupling mirror 34, since the efficiency thereof, as a rule, drops when acting on a broad spectral and angle range.

Although this is not mandatory, the light source 6 preferably emits linearly polarized light. Particularly preferably, the linear polarization lies perpendicular to the plane that spans the slow (short) axis of the diode 6. A typical buried dichroic element is particularly efficient for this polarization. If the polarization is perpendicular to this preferred axis—as is the case for laser diodes 6 made available by technology—a retardation plate or film (λ/2 plate) can be introduced along the beam path according to the invention, said retardation plate or film rotating the polarization direction after the passage through the retardation plate or film. The retardation plate or film is preferably introduced into the collimated beam, i.e., for example, downstream of the collimation optical unit 8 or prior to input coupling into the spectacle lens 4.

The collimation optical unit 8, which converts the light 10 of the light source 6 into a virtually parallel beam, is situated downstream of the source 6 in the light direction. An advantage of this configuration lies in a certain variability of the distances such that, as a result thereof, the optical system 7 can be fitted to different head sizes of the users.

The collimation optical unit 8 can have an embodiment that is refractive (spherical or aspherical lenses), mirroring (imaging mirrors) and/or diffractive (imaging diffractive elements).

The deflection prism 9, which steers the collimated rays 10 out of the spectacle earpiece in the direction of the spectacle lens 4, is arranged downstream of the collimation optical unit 8. The design of the prism 9 is fitted to the given form of the spectacles.

Subsequently, this is followed by the input coupling optical unit or the input coupling prism 32, which focuses the collimated laser light 10 into the spectacle lens 4. The input coupling is implemented at a suitable angle such that, as mentioned above, the output coupling mirror 34 is struck after a certain number of total-internal reflections. The focal length of the input coupling optical unit 32 is chosen in such a way that, in conjunction with the imaging buried mirror 34, the light focus 16 arises at a desired distance from the pupil of the eye 14. The focal length of the input coupling optical unit 32 preferably lies in the range of between 20 mm and 100 mm and particularly preferably between 30 mm and 60 mm.

A modification of the embodiment shown in FIG. 18 is shown in FIG. 19. In this modification according to FIG. 19, a diffusion screen 37 with a small scattering angle is introduced at a suitable point into the beam path between the source 6 and the eye 14. The diffusion screen 37 is preferably positioned at a plane conjugate to the pupil of the eye. According to the invention, the aforementioned focal lengths, spectacle lens thicknesses and distances are chosen in such a way that this plane arises at a small distance upstream of the deflection prism 8. By way of example, the distance can be 1 mm, 2 mm, 3 mm, 4 mm, 5 mm, 6 mm, 7 mm, 8 mm, 9 mm or 10 mm.

The diffusion screen 37 has been attached to the relevant point in the illustration of FIG. 19. The labeled rays of the beam 10 are provided with a statistical change in direction at the diffusion screen 37. Consequently, an enlarged light spot 16 arises both in the spectacle lens 4 and virtually in front of the eye 14. The beam grid in the pupil plane of the eye 14 is not influenced thereby.

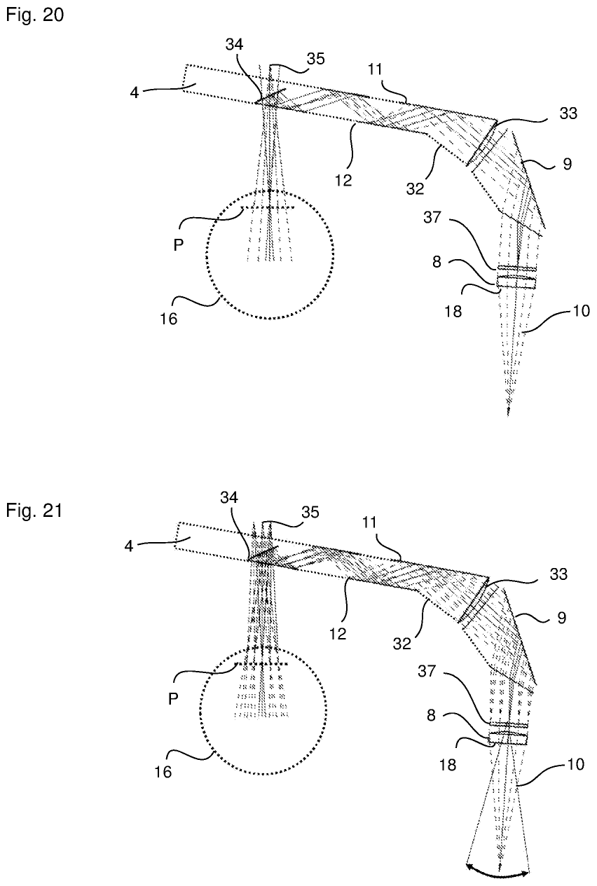

The illustration in FIG. 20 elucidates the imaging of the diffusion screen 37 into the pupil of the eye. Rays that start at one point at the diffusion screen 37 are reunified at a point in the pupil plane. This is plotted in exemplary fashion for a point by way of solid lines in FIG. 20.

FIG. 21 schematically shows the most likely adjustment of the system for different angles of incidence in the pupil of the eye. A mechanical rotation of the collimation optical unit 8 with laser source 6 and diffusion screen 37 is converted into a virtual rotation of the rays in the pupil plane. As a result, the angle of incidence of the rays on the eye 14 is set.

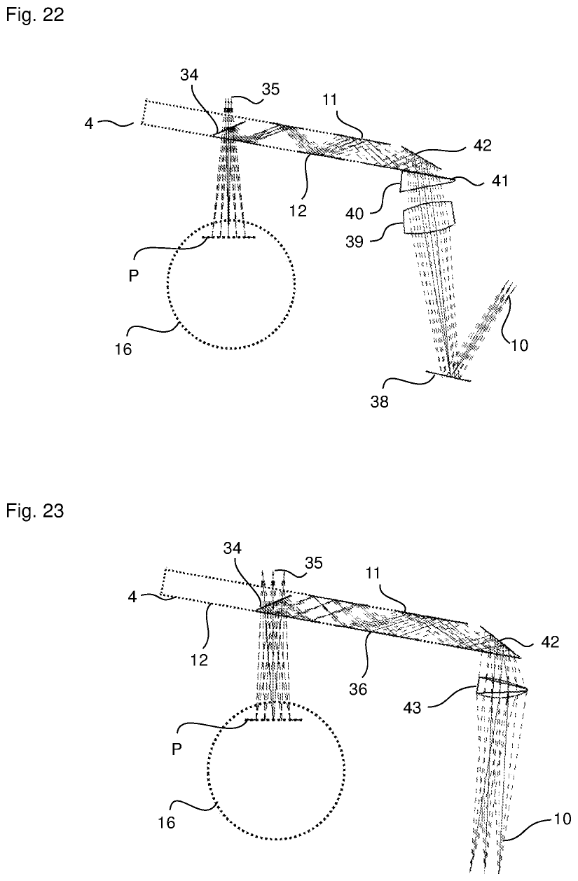

FIG. 22 shows a further image, in which the splitter layer 34 is embodied as a plane, and hence non-curved, layer. In contrast to the embodiments described previously, a deflection mirror 38 is disposed downstream of the laser source 6, which may optionally comprise a fast-axis collimator. The deflection mirror 38 may have a scattering function and/or be tiltable. A lens 39 with imaging surfaces is disposed downstream of the deflection mirror 38. The imaging surfaces may be spherical or aspherical or have an embodiment as free-form surfaces. A wedge 40, which is spaced apart from the back side 12 of the spectacle lens 4 by an air gap 41, is disposed downstream of the lens 39. The light rays 10 enter into the spectacle lens 4 via the air gap 41 and are deflected by a plane surface 42, formed at the front side 11, in the spectacle lens in such a way that they are guided up to the splitter layer 34 by total-internal reflection.

FIG. 23 shows a further modification. Once again, the laser source 6 may comprise a fast-axis collimator where necessary, with different adjustment states being plotted in the illustration of FIG. 23. A lens 43 with imaging surfaces is disposed downstream of the source 6. The surfaces may have spherical or aspherical curvature or may be embodied as free-form surfaces. Here, the surface 42 is embodied as an imaging mirror, which may have spherical or aspherical curvature or which may be embodied as free-form surfaces. Moreover, an imaging diffractive element 36 is formed at the back side 12 in such a way that it replaces the total-internal reflection at this point. The imaging effect of the splitter layer 34 can be replaced by the element 36. Hence, the splitter layer 34 can have a plane embodiment, for example.

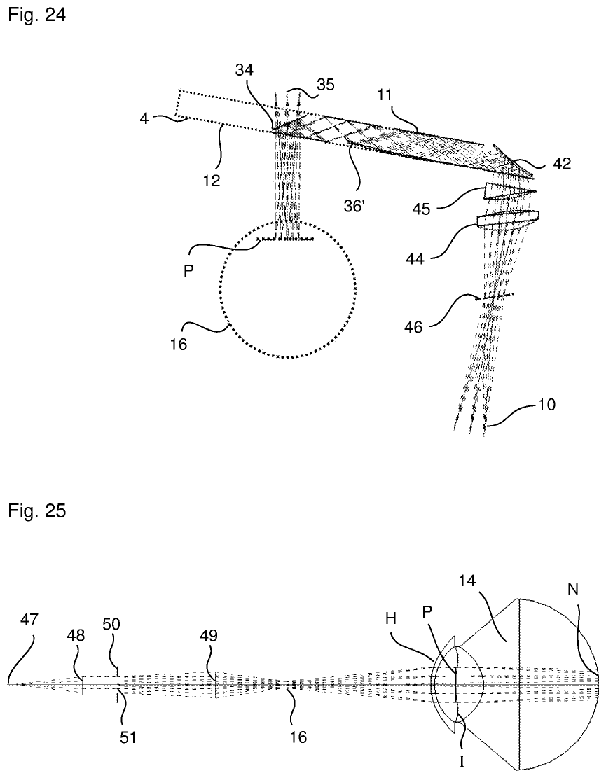

The modification shown in FIG. 24 differs from the embodiment according to FIG. 23 in that two lenses 44 and 45 are arranged in place of the lens 43. The lens 45 may comprise a plane surface and a spherically curved, aspherically curved or a free-form surface. The lens 44 preferably comprises two curved surfaces, which in turn may be spherically or aspherically curved or may be embodied as a free-form surface. A diffusion screen 46 can be positioned between the laser source 6 and the lens 44. The diffusion screen 46 can have a rotatable arrangement. This can be used for adjustment purposes. Further, in contrast to the embodiment of FIG. 23, a curved mirror 36′, not an imaging diffractive element 36, is provided. The curved mirror 36′ can be embodied on the back side or at least partly buried in the spectacle lens 4. Further, it can have dichroic coating and/or be embodied as a free-form mirror 36′. The curved mirror 36′ can replace the imaging effect of the splitter layer 34. Hence, the splitter layer 34 can have a plane embodiment, for example.

The adjustment possibility described in conjunction with FIGS. 21 to 24 can also be used to produce a virtual focus 35 with a lateral extent of at least 0.1 mm or at least 1.0 mm. To this end, all that is necessary is to arrange an extended light source, which covers the adjustment region, or an optical element with a scattering property (such as, e.g., a diffusion screen, a hologram and/or volume hologram), which covers the adjustment region, in the region of the plotted start points of the beams 10. Consequently, all indicated or plotted beams 10 are produced simultaneously, as a result of which the lateral extended virtual focus 35 arises.

A further embodiment of the illumination apparatus 1 for producing a virtually extended light source or a focus 16 with a lateral extent of at least 0.1 mm is shown schematically in FIG. 25. Here, a point source 47 is situated in the front focus of a first lens 48. As a result, the beam 10 emitted by the point source 47 is collimated and brought to a focus 16 in front of the eye 14 by a second lens 49 disposed downstream of the first lens 48. Situated between the first and the second lens 48, 49 there is a stop 50, the distance of which from the second lens 49 is chosen in such a way that the stop 50 is imaged onto the iris I of the eye 14. A diffusion screen 51 has been introduced into the stop plane such that the focus 16 in front of the eye 14 is enlarged laterally (i.e., transversely to the propagation direction) in accordance with the divergence of the diffusion screen 51. However, no light is cut at the iris I by imaging the diffusion screen 51 into the pupil P of the eye. Preferably, the lateral extent of the focus 16 is such that it is at least 0.1 mm. In particular, the lateral extent of the focus 16 can have a diameter D, wherein preferably 0.1 mm≤D≤15 mm, in particular 1 mm≤D≤15 mm and particularly preferably 2 mm≤D≤10 mm. Should the focus 16 not be circular, the diameter D describes the diameter of the smallest circle in which the focus 16 is completely contained.

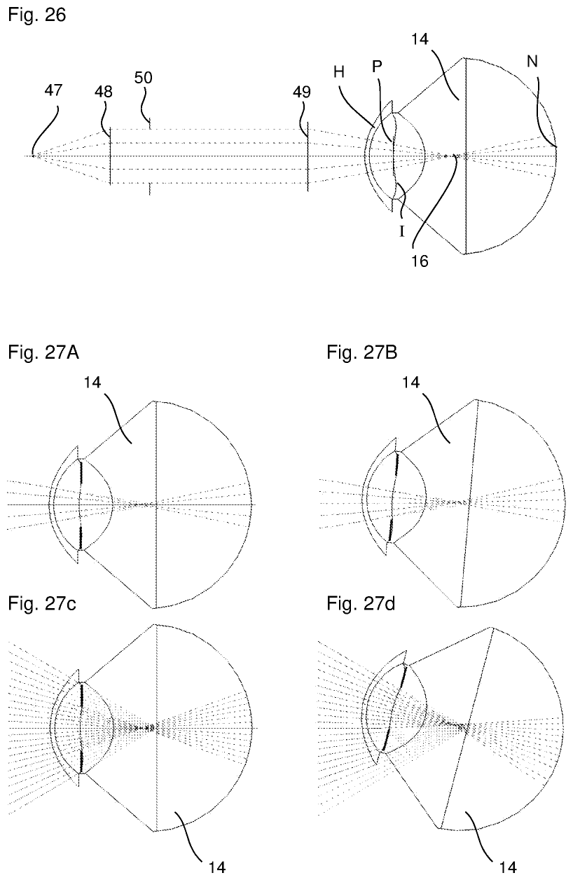

FIG. 26 shows a further embodiment of the illumination apparatus 1. The structure substantially corresponds to the structure according to the embodiment of FIG. 25. Only the diffusion screen 51 is omitted and the illumination apparatus 1 is positioned in relation to the eye 14 of the user in such a way that the focus 16 of the point source 47 is imaged into the center of rotation of the eye 14. Naturally, minor deviations are also possible. Thus, it is possible, for example, for the focus 16 to lie in a region along the propagation direction around the center of rotation 15, which is ±1 mm, ±2 mm, ±3 mm, ±4 mm or ±5 mm.

In this embodiment, the divergence or the numerical aperture of the imaged point source 47 determines the maximum angle of rotation of the eye 14, at which light still reaches the retina N through the iris I. The surface illuminated on the retina N is restricted by the size of the pupil P of the eye. The described embodiment is particularly preferred if the implant 2 to be illuminated is situated on the retina, a large range of the angle of rotation of the eye is intended to be covered and the implant 2 itself has a relatively small lateral extent.

FIGS. 27A, 27B, 27C and 27D show different rotational positions of the eye 14. What emerges from the illustrations is that surfaces of similar size are always illuminated on the retina N, even in the case of large rotations of the eye 14. Here, the dotted rays show the propagation of the beam without the presence of the eye 14 (and hence in air). They intersect at the center of rotation of the eye 14. The dashed rays take account of the refraction at the cornea H and lens of the eye L of the eye. Thus, their focus lies slightly offset from the actual mechanical center of rotation 15 of the eye 14. The illuminated surface on the retina N is restricted by the pupil diameter of the eye 14 in the embodiment according to FIG. 26. Once the implant 2 has reached a certain size it can no longer be illuminated in the entirety thereof.

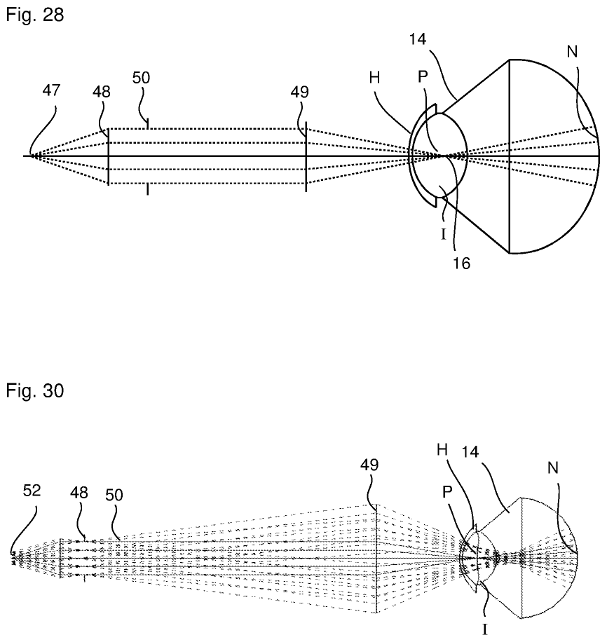

Therefore, the illumination device 1 can also be embodied in such a way that the point source 47 is imaged into the plane of the pupil P of the eye (or in a range along the propagation direction of the beam 10 of ±1 mm, ±2 mm, ±3 mm, ±4 mm or ±5 mm). Then only the divergence of the point source 47 or the numerical aperture of the imaging determines the surface illuminated on the retina N. Even very large retinal implants 2 can be illuminated as a result. Moreover, this configuration is slightly more robust in relation to the lateral offset of the eye 14. The latter does not change the surface illuminated on the retina N for as long as it is smaller than half the pupil diameter of the iris I of the eye 14. The structure of such an illumination apparatus 1 is shown schematically in FIG. 28.

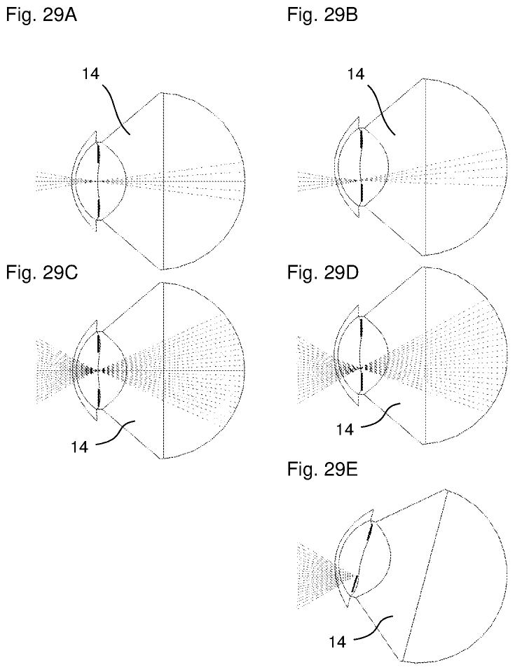

By contrast, shadowing at the iris I arises quickly, particularly if the latter is very small, in the case of a rotation of the eye 14. Therefore, the described embodiment is particularly preferred if the implant 2 to be illuminated is situated on the retina N, if a very large surface on the retina N has to be illuminated for operating the implant 2, if only small lateral displacements of the eye 14 are expected during operation and if the expected eye rotations are likewise very small during operation. FIGS. 29A, 29B, 29C and 29D show various lateral positions of the eye 14 (additionally, a different rotational position as well in FIG. 29D) in the variant of imaging the point source into the plane of the pupil P of the eye. What can be gathered from these illustrations is that the size of the illuminated surface on the retina N is not restricted by the pupil P of the eye.

FIG. 30 schematically shows an embodiment of the illumination device 1, in which the beams of an extended source 52 are imaged on a curved surface within the eye 14. By way of example, the curved surface can be a spherical surface. To this end, the first and second lens 48 and 49 are disposed downstream of the extended light source 52, the distances of said first and second lens from the light source 52 and from the eye 14 and from one another being chosen in such a way that the desired imaging is produced. Moreover, the stop 50 is arranged between the two lenses 48 and 49, wherein the stop 50 can be embodied as a variable stop. As a result, the divergence of the source 52 and the size of the illuminated surface on the retina can be set in a targeted manner.

In particular, imaging the extended source 52 onto the curved surface can be carried out in such a way that the axial focus, i.e., the image of a selected point of the source 52, is situated in the pupil plane of the eye 14. The center of curvature of the curved image face, on which the extended source 52 is imaged, may be situated in the center of rotation of the eye 14. As a result of such an embodiment, it is possible to reduce the local power density in the eye in comparison with the embodiments according to FIGS. 25 to 29.

The surface illuminated on the retina is still determined by the divergence of the source 52, i.e., the numerical aperture of the imaging, and therefore not restricted by the pupil dimensions. As a result of the curvature and orientation of the image surface in the eye 14 according to the invention, the alignment of the retina N does not change when the eye rotates provided the extent of the image of the source 52 itself is sufficiently large. The energy now is distributed over a larger area, i.e., the radiant intensity drops drastically in comparison with the embodiments according to FIGS. 25 to 29. The system is also slightly more robust in relation to the lateral eye offset on account of the extended source 52.

This embodiment is particularly preferred if the implant 2 to be illuminated is situated on the retina, if a large surface on the retina N has to be illuminated for the operation of the implant 2, if the expected eye rotations during the operation are likewise large, if the relevant biological limits of the radiant intensity are exceeded when using point sources of little extent on account of the required overall power and if lateral eye displacements tend to be small or moderate during the operation.

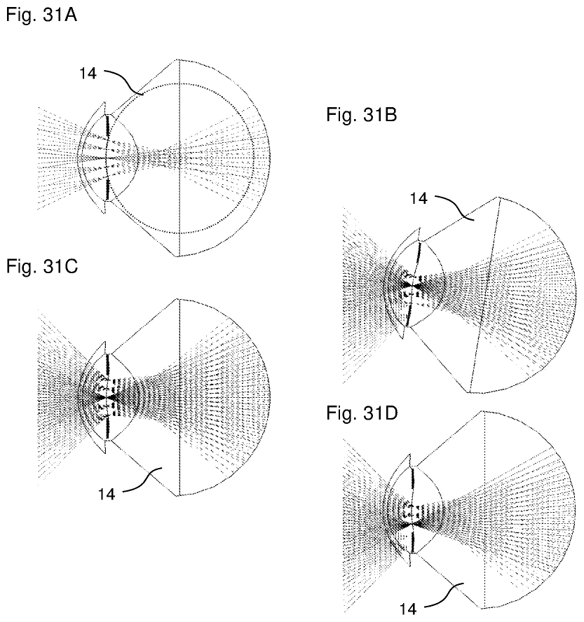

FIGS. 31A to 31D show different positions (lateral positions and rotational positions) of the eye during the described illumination.

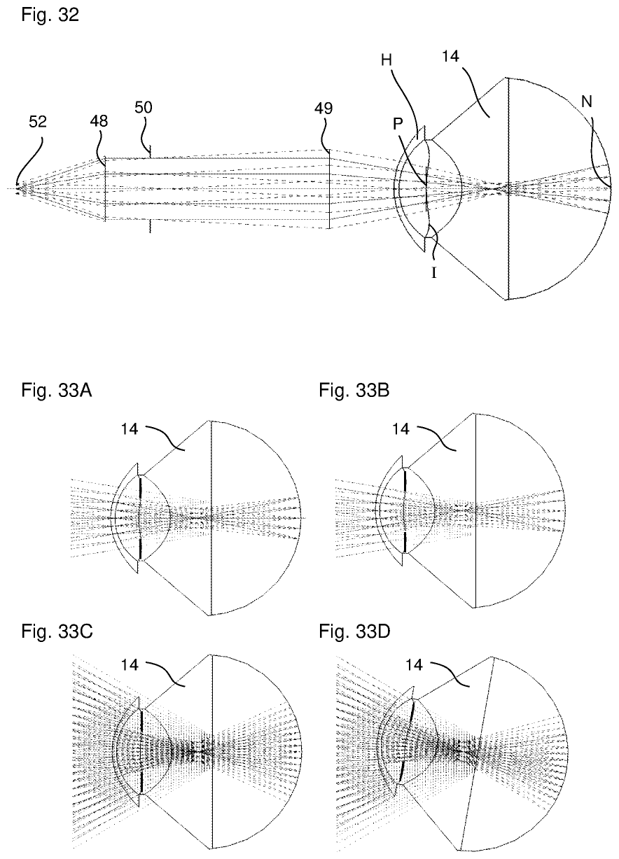

FIG. 32 illustrates a modification of the embodiment of FIG. 26, in which use is not made of a point light source 47 but of the extended light source 52 such that the latter is imaged into the center of rotation of the eye 14. Consequently, telecentric illumination of the center of rotation is present, and so the chief rays in the imaging are approximately parallel.

This ensures that the light distribution offered to the eye 14 does not change when the eye 14 is displaced laterally in relation to the light source 52. Illumination continues to be possible on account of the imaging into the center of rotation 15 of the eye 14, even in the case of large angles of rotation of the eye 14. The radiant intensity can be low on account of the extended light source 52.

This embodiment is particularly preferred if the implant 2 to be illuminated is situated on the retina, with a large range of the angle of rotation of the eye intended to be covered, if the implant itself has a relatively small lateral extent and if the relevant biological limits of the radiant intensity are exceeded when using point sources of little extent on account of the required overall power.

The source 52 is situated in the front focus of the first lens 48 and the center of rotation 50 of the eye 14 is situated in the back focus of the second lens 49. Consequently, the source 52 is imaged into the center of rotation 15. Further, a telecentricity stop 50 is situated in the front focus of the second lens 49 such that the chief rays used for the imaging are incident on the eye 14 in parallel.

FIGS. 33A-D schematically illustrate this illumination for various positions of the eye 14.

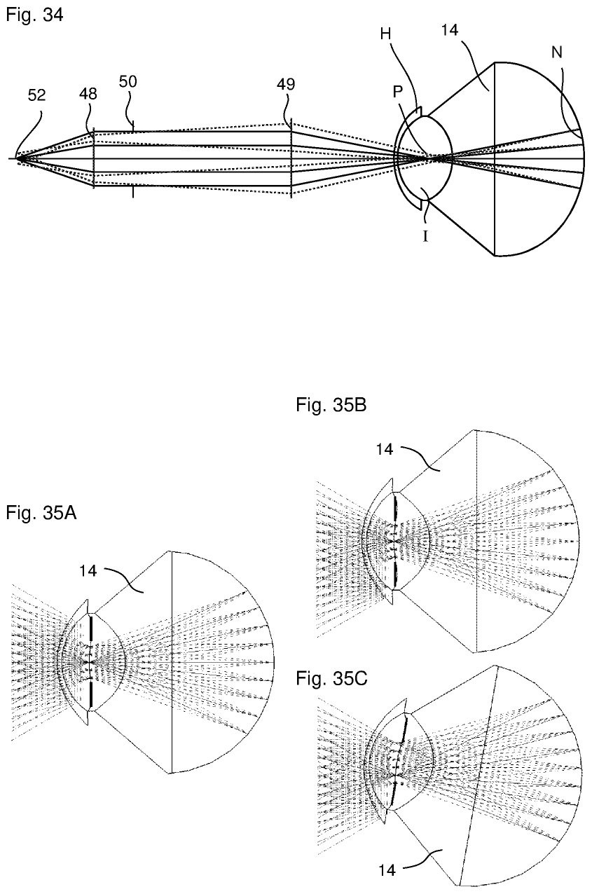

FIG. 34 shows a modification of the embodiment according to FIG. 32. The distances are chosen in such a way that the focus 16 lies in the pupil plane P of the eye 14. Consequently, telecentric imaging of an extended source 52 into the pupil plane of the eye 14 is realized, as a result of which the illumination is robust in relation to lateral displacements of the eye 14. Additionally, the surface illuminated on the retina N is no longer limited by the iris of the eye 14. Rather, the size of this area can be set in targeted fashion by way of the employed divergence or numerical aperture of the imaging. By way of example, this can avoid unnecessary swamping of the implant 2 on the retina.

This embodiment is particularly preferred if the implant 2 to be illuminated is situated on the retina, if a very large surface on the retina N has to be illuminated for the operation of the implant 2, if very large lateral displacements of the eye are expected during the operation, if the expected eye rotations during the operation are moderate, if the relevant biological limits of the radiant intensity are exceeded when using point sources of little extent on account of the required overall power and if the energy budget requires an energy distribution that is delimited as sharply as possible on the retina with little swamping.

FIGS. 35A-C show different positions (lateral positions and rotational positions) of the eye in the case of this telecentric imaging of the extended source into the pupil plane of the eye.

Further, the illumination apparatus can be embodied in such a way that non-telecentric imaging of an extended light source into the center of rotation 15 of the eye 14 is implemented. By way of example, this can be achieved by virtue of the stop 50 present in the illumination system not being imaged to infinity. By way of example, this is advantageous if the illumination should be achieved by an optical system with little installation space that is worn on the head, for example in the form of spectacles. The stop of the illumination system can then lie directly in the spectacle substrate, minimizing the spectacle cross section required for the spectacles despite the large range of angle of rotation of the eye that can be covered.

Such an embodiment is particularly preferred if the implant 2 to be illuminated is situated on the retina, with a large range of angle of rotation of the eye intended to be covered in the process, if the implant 2 itself, however, has a relatively small lateral extent, if the relevant biological limits of the radiant intensity are exceeded when using poorly developed point sources on account of the required overall power and if the lateral displacements of the eye 14 to be expected tend to be moderate during the operation and if the installation space of the illumination optical system should be as compact as possible.

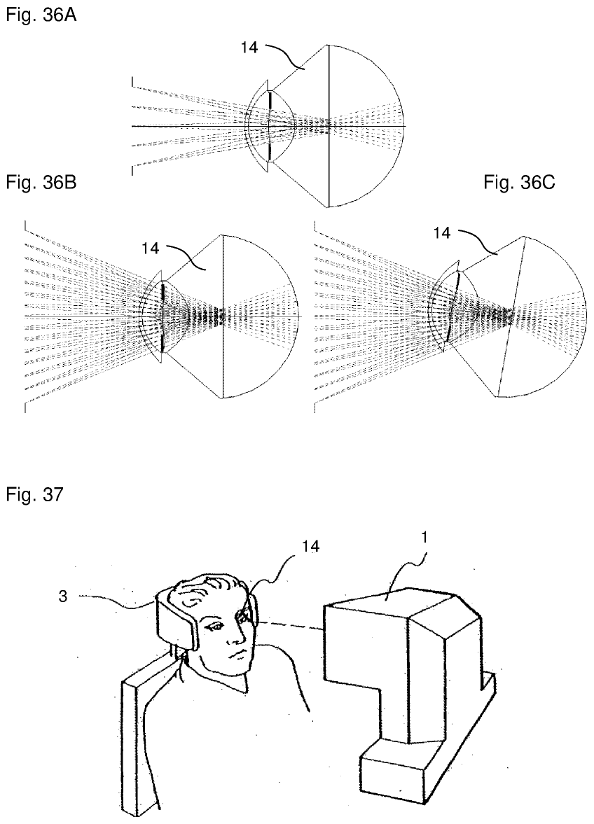

FIGS. 36A-C show different positions of the eye in the case of such an illumination.

As already described, the described embodiments of the illumination apparatus 1 can be embodied as being wearable on the head of the user. In particular, they can be embodied in the form of spectacles. Naturally, the light source 6 can be formed not only in the right spectacle earpiece, as shown in FIG. 1, but can be alternatively or additionally formed on the left spectacle earpiece. In this case, the illumination with illumination radiation of the light source at the left spectacle earpiece can preferably be implemented by way of the second spectacle lens 5, which may have a corresponding embodiment to that of the first spectacle lens 4 (preferably a mirrored embodiment in relation to the first spectacle lens).

However, the illumination apparatus 1 could also be embodied as a separate appliance (FIG. 37), in front of which the user sits down, for example, and then gazes on the illumination optical unit 7. By way of example, this can be realized by displaying a target point to be observed. Further, a rest 3 (e.g., headrest) can be formed, alternatively or additionally, on the appliance or at a fixed distance from the appliance, as is conventional for examination appliances at the ophthalmologist.

Until now, the illumination apparatus according to the invention has always been described in conjunction with the energy supply of the eye implant 2. However, as an alternative or in addition thereto, it is also possible to communicate with the eye implant 2 using the illumination apparatus. To this end, the beam 10 is modulated, for example (by way of example, an intensity modulation and/or frequency modulation can be carried out). Consequently, it is possible to transfer data to the eye implant 2. Bidirectional communication between the illumination apparatus 1 and the eye implant 2 is also possible in one development.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

1-10. (canceled)

11. An apparatus for supplying energy to and/or communicating with an ocular implant by means of illumination radiation, the apparatus comprising:
a positioning unit that sets an illumination position of the eye of a user;
an optical input interface that supplies illumination radiation; and
an illumination optical unit,
wherein the illumination optical unit focuses the supplied illumination radiation such that a focus with a lateral extent of at least 0.1 mm in air is present and that, when the eye of the user is in the set illumination position, the illumination radiation enters into the eye as a convergent beam such that the focus lies within the eye.

12. The apparatus of claim 11, wherein the illumination optical unit is configured such that the focus lies in the region between the pupil of the eye and the center of rotation of the eye when the eye of the user is in the set illumination position.

13. The apparatus of claim 12, wherein the illumination optical unit comprises an optical element with a scattering effect that produces the lateral extent of the focus.

14. The apparatus of claim 12, wherein the illumination optical unit is configured to provide non-telecentric imaging of the illumination radiation into the center of rotation of the eye if the eye of the user is in the set illumination position.

15. The apparatus as claimed of claim 12, wherein the illumination optical unit is configured to carry out telecentric imaging of the illumination radiation beams in such a way that, if the eye of the user is in a set illumination position, the focus lies in the center of rotation of the eye.

16. The apparatus of claim 12, wherein the illumination optical unit is configured to image the illumination radiation in telecentric fashion in such a way that, if the eye of the user is in the set illumination position, the focus lies in the pupil of the eye.

17. The apparatus of claim 11, wherein the illumination optical unit comprises an optical element with a scattering effect for producing the lateral extent of the focus.

18. The apparatus of claim 11, wherein the illumination optical unit images the illumination radiation such that the focus lies on a curved surface.

19. The apparatus of claim 18, wherein the illumination optical unit is configured such that the surface is spherically curved and, if the eye of the user is in the set illumination position, the center of curvature of the spherical surface lies at the center of rotation of the eye and the spherical surface extends through the pupil of the eye.

20. The apparatus of claim 11, wherein the illumination optical unit is configured to provide non-telecentric imaging of the illumination radiation into the center of rotation of the eye if the eye of the user is in the set illumination position.

21. The apparatus of claim 11, wherein the illumination optical unit configured to provide telecentric imaging of the illumination radiation beams in such a way that, if the eye of the user is in a set illumination position, the focus lies in the center of rotation of the eye.

22. The apparatus of claim 11, wherein the illumination optical unit is configured to image the illumination radiation in telecentric fashion in such a way that, if the eye of the user is in the set illumination position, the focus lies in the pupil of the eye.

23. The apparatus of claim 11, further comprising a source that emits the illumination radiation.

24. The apparatus of claim 11, wherein the positioning unit is configured to be placed on the head of the user.
